(19) United States
(12) Patent Application Publication
(10) Pub. No.: US 2024/0296750 A1
(43) Pub. Date: Sep. 5, 2024

(54) INFORMATION PROCESSING APPARATUS, INFORMATION PROCESSING METHOD AND RECORDING MEDIUM

(71) Applicant: CASIO COMPUTER CO., LTD., Tokyo (JP)

(72) Inventor: Takuya SAITO, Tokyo (JP)

(73) Assignee: CASIO COMPUTER CO., LTD., Tokyo (JP)

(21) Appl. No.: 18/585,490

(22) Filed: Feb. 23, 2024

(30) Foreign Application Priority Data
Mar. 1, 2023 (JP) 2023-031374

(51) Int. Cl. G09B 7/04; G09B 5/02; G09B 7/06

(52) U.S. Cl. CPC G09B 7/04; G09B 5/02; G09B 7/06

(57) ABSTRACT

An information processing apparatus includes a control unit that performs processes of: displaying a determination screen for having a person who determines make a determination on an answer made by a person who answers on a display device in the case where it is specified that a person determines whether the answer is good or not for a question answered by the person who answers; and storing a result of the determination by the person entered on the determination screen in association with the question into a memory.

### BACKGROUND

### 1. Field

This disclosure relates to an information processing apparatus, an information processing method, and a recording medium.

### 2. Related Art

Information processing apparatuses such as electronic dictionaries in recent years are able to record not only dictionary contents but also workbook contents as contents for supporting user learning. The workbook content may be used to check the user's own learning progress. In recent years, a function of automatic scoring of user's answers has also been considered (for example, Japanese Unexamined Patent Application Publication No. 2010-107787).

Some questions have answers whose results are able to be easily divided into correct and incorrect answers, while others not. Questions for which answer results are able to be easily divided into correct and incorrect answers are mark-sheet or other selection questions, numerical calculation questions, and the like. In each of these selection questions and numerical calculation questions, there is only one correct answer. On the other hand, questions for which answer results are not be able to be easily divided into correct and incorrect answers are English composition and other essay-type questions, speaking questions, mathematical proof questions, and so on.

### SUMMARY

According to an aspect of this disclosure, an information processing apparatus includes a control unit that performs the processes of: displaying a determination screen for having a person who determines make a determination on an answer made by a person who answers on a display device in the case where it is specified that a person determines whether the answer is good or not for a question answered by the person who answers; and storing a result of the determination by the person entered on the determination screen in association with the question into a memory.

### BRIEF DESCRIPTION OF THE DRAWINGS

FIG. 1 is a diagram illustrating an example of a configuration of a system according to one aspect of the disclosure.

FIG. 2 is a diagram illustrating a detailed configuration of the system.

FIG. 3 is a diagram illustrating an example of test result data.

FIG. 4 is a diagram illustrating an example of a screen display by an application running on a web browser of a terminal.

FIG. 5 is a flowchart illustrating the workbook content execution process on the terminal.

FIG. 6 is a diagram illustrating an example of the top screen of the workbook content.

FIG. 7 is a flowchart illustrating a process of submitting questions.

FIG. 8 is a diagram illustrating a first example of a display screen for a question.

FIG. 9 is a diagram illustrating a second example of a display screen for a question.

FIG. 10 is a flowchart illustrating a scoring process.

FIG. 11 is a diagram illustrating an example of a first score confirmation screen.

FIG. 12 is a diagram illustrating an example of a scoring result screen.

FIG. 13 is a diagram illustrating an example of a second score confirmation screen.

FIG. 14 is a diagram illustrating an example of a determination screen.

FIG. 15 is a diagram illustrating an operation of a server after a terminal is instructed to activate the workbook content.

### DETAILED DESCRIPTION

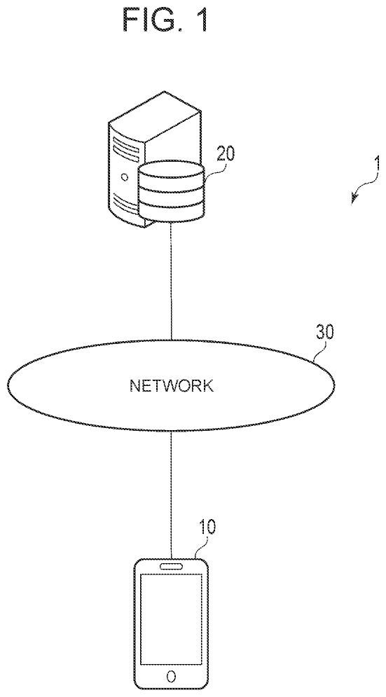

One embodiment is described with reference to the drawings. FIG. 1 is a diagram illustrating an example of the configuration of a system 1 according to one embodiment. The system 1 includes a terminal 10 and a server 20. The terminal 10 and the server 20 are communicatively connected via a network 30. The network 30 is, for example, the Internet. Although only one terminal 10 is illustrated in FIG. 1, the number of terminals 10 is not limited to one. In other words, there can be more than one terminal 10.

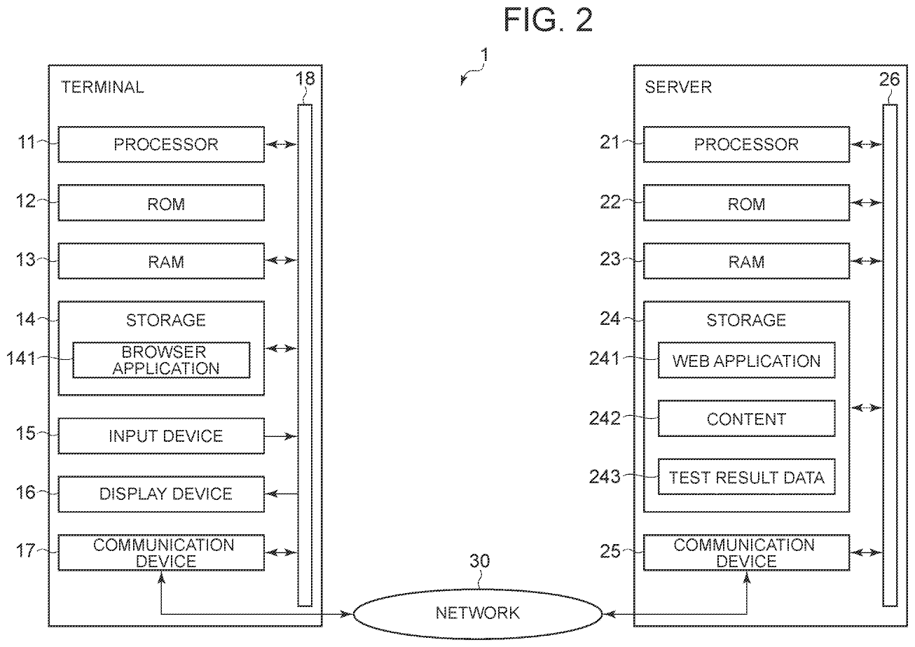

FIG. 2 is a diagram illustrating a detailed configuration of the system 1. The terminal 10 is an information processing apparatus having a processor 11, a ROM 12, a RAM 13, a storage 14, an input device 15, a display device 16, and a communication device 17. Each thereof is connected to each other via a system bus 18. The terminal 10 may be an electronic device having browser functions of a personal computer (PC), a tablet terminal, a smart phone, or the like. The terminal 10 may also be an electronic dictionary or the like having communication functions.

The processor 11 is a processor that controls various operations of the terminal 10. The processor 11 may be an integrated circuit including a central processing unit (CPU) or the like. Processors other than the CPU, such as an application specific integrated circuit (ASIC), a field programmable gate array (FPGA), a graphic processing unit (GPU), and the like may be used as the processor 11. The processor 11 is able to operate as a control unit by performing processes according to a web application on the server 20.

The ROM 12 records a startup program or the like of the terminal 10. The RAM 13 is a main memory for the processor 11 and so on.

The storage 14 is able to operate as a memory. The storage 14 stores various programs such as terminal control programs used by the processor 11, parameters, and so on. The processor 11 controls the operations of the terminal 10 by executing various programs in response to input signals and the like from the input device 15. The various programs include, for example, a browser application 141. The browser application is an application program for displaying contents provided by the server 20 on the display device 16.

The input device 15 includes a keyboard, a mouse, a touch panel, and so on. The input device 15 may also include an audio input device such as a microphone, and an image input device such as a camera. In response to a user operation via the input device 15, a signal indicating the content of the user operation is input to the processor 11 via the system bus 18.

The display device 16 is a liquid crystal display, an organic EL display, or the like. The display device 16 may be provided as an integral part of the terminal 10, or may be provided separately from the terminal 10. Various images are displayed on the display device 16.

The communication device 17 includes a circuit for communicating with an external communication network such as the network 30. The communication device 17 is able to operate as a communication unit.

The server 20 is an information processing apparatus having a processor 21, a ROM 22, a RAM 23, a storage 24, and a communication device 25. These devices are connected to each other via a system bus 26.

The processor 21 is a processor that controls various operations of the server 20. The processor 21 may be an integrated circuit including the CPU and so on. Processors other than the CPU, such as, for example, ASIC, FPGA, GPU, and the like, may be used as the processor 21. The processor 21 is able to operate as a control unit by performing processes according to a server control program.

The ROM 22 stores information used for an operation of the processor 21 or the like. The RAM 23 is a main memory for an operation of the processor 21 or the like.

The storage 24 is able to operate as a memory. The storage 24 stores various programs such as server control programs or the like used by the processor 21, parameters, and so on. The processor 21 controls an operation of the server 20 by executing various programs. The various programs include a web application 241. The web application 241 is an educational application that is executed on a web browser of the terminal 10. The web application 241 may be an educational platform application that integrally manages various contents provided for education, such as contents 242 including, for example, a dictionary content, a computer content, and a workbook content.

In addition, the storage 24 may store test result data 243. The test result data 243 is data of scoring results of the questions submitted in the workbook contents. The test result data 243 may be managed for each user of the web application 241. The test result data 243 may also be managed by the date of the test.

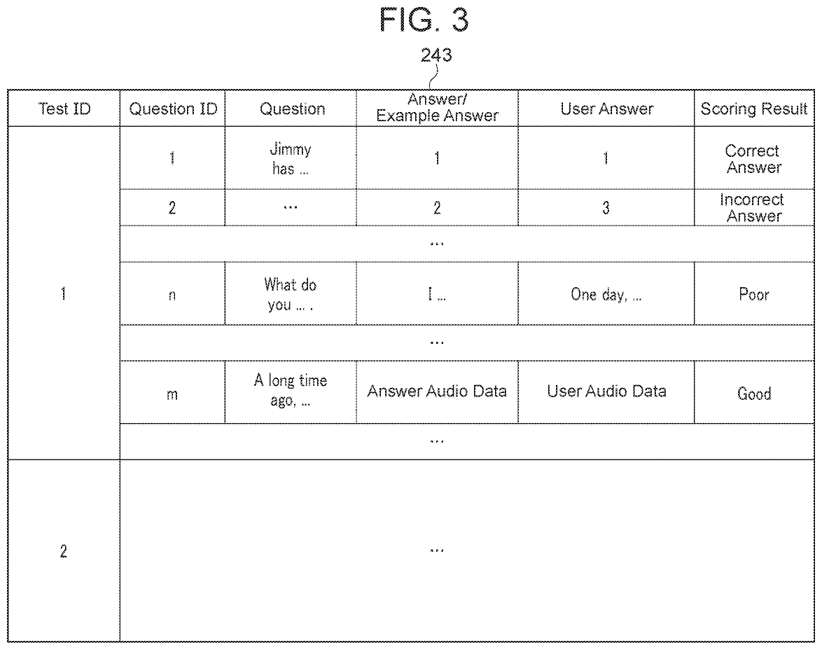

FIG. 3 is a diagram illustrating an example of the test result data 243. The example test result data includes a test ID, a question ID, question data, answer/example answer data, user answer data, and scoring result data.

The test ID is an ID assigned to each test. There may be one test for one workbook or a plurality of tests for one workbook. The question ID is an ID assigned to each question. Each question may be assigned to one of big questions. In this case, the question ID may be associated with the ID of each big question.

Question data is the actual data of a question with the corresponding question ID, corresponding to the question data contained in the workbook content. Question data is, for example, text data that represents the content of the question. In the case of English listening questions and the like, the question data may be in the form of audio data or the like other than text data.

The answer/example answer data is the actual data of an answer or an example answer of a question with the corresponding question ID, which corresponds to the answer/example answer data included in the workbook content. The answer/example answer data for a question for which the correct answer is uniquely determined, such as a selection question, is the actual data of the answer. On the other hand, the answer/example answer data for a question for which the correct answer is not uniquely determined, such as an English composition question, is the actual data of an example answer that represents a model answer to the question. The answer/example answer data is text data representing, for example, an answer or an example answer. In the case of an English speaking question or the like, the answer/example answer data may be in the form of audio data or the like other than text data. For example, the questions with question IDs 1 and 2 in FIG. 3 are choice type questions. In this case, the answer/example answer data represents the choice of a correct answer. On the other hand, the question with a question ID n in FIG. 3 is an English composition question. In this case, the answer/example answer data is text data of an example answer in English. In addition, the question with a question ID m in FIG. 3 is a speaking question. In this case, the answer/example answer data is audio data of the speech recordings of the example answer. In this respect, the answer/example answer data that includes an example answer may include a commentary about the example answer in addition to the example answer.

The user answer data is actual data of the user's answer to the question with the corresponding question ID. The answer data is, for example, text data representing an answer. In the case of an English speaking question or the like, the answer data may be in the form of audio data or the like other than text data. For example, the user answer data with the question IDs 1 and 2 in FIG. 3 are data representing the choices answered by the user. The user answer data with the question ID n in FIG. 3 is text data of English sentences of answers made by the user. The user answer data with the question ID m in FIG. 3 is audio data of recorded user voice.

The scoring result data is data of scoring result of a user's answer to the question with the corresponding question ID. For a question for which the correct answer is uniquely determined, such as a selection question, the scoring result data is the data of a correct answer, an incorrect answer, or no answer. On the other hand, the scoring result data for a question for which the correct answer is not uniquely determined, such as an English composition question, is data of either the result of the user's self-determination or no answer. In the case of self-determination, the user determines a result of the comparison between the user's answer and the example answer that represents the model answer (the result of determining whether the answer is good or not) on three levels of “Good,” “Average,” or “Poor,” for example. The result of the determination is recorded as scoring result data. The self-determination is described in detail later. The user's determination of whether an answer is good or not may include cases where the user determines whether the answer is correct or incorrect by comparing an example answer with the user's answer, or where the user determines the relevance of an answer and whether the answer is appropriate or not.

The communication device 25 includes a circuit for communicating with an external communication network, such as the network 30. The communication device 25 may operate as a communication unit.

In one example, a user specifies the address of the server 20 in a web browser running on the terminal 10. At this time, a display screen for a web application stored in the server 20 is displayed on the web browser of the terminal 10. A request to the server 20 is issued in response to an operation via the input device 15 on this display screen. This operation includes activating a dictionary content, activating a workbook content, and various input operations on the user's work area. The server 20 performs a process in response to a request and returns the result of the process to the terminal 10 as a response. The terminal 10 displays the contents according to the user's operation according to a response from the server 20. In this way, the system 1 implements functions as web applications by the program running on the web browser of the terminal 10 and the program of the server 20.

Such a web application may be used, for example, in the field of school education where information and communication technology (ICT) is advancing.

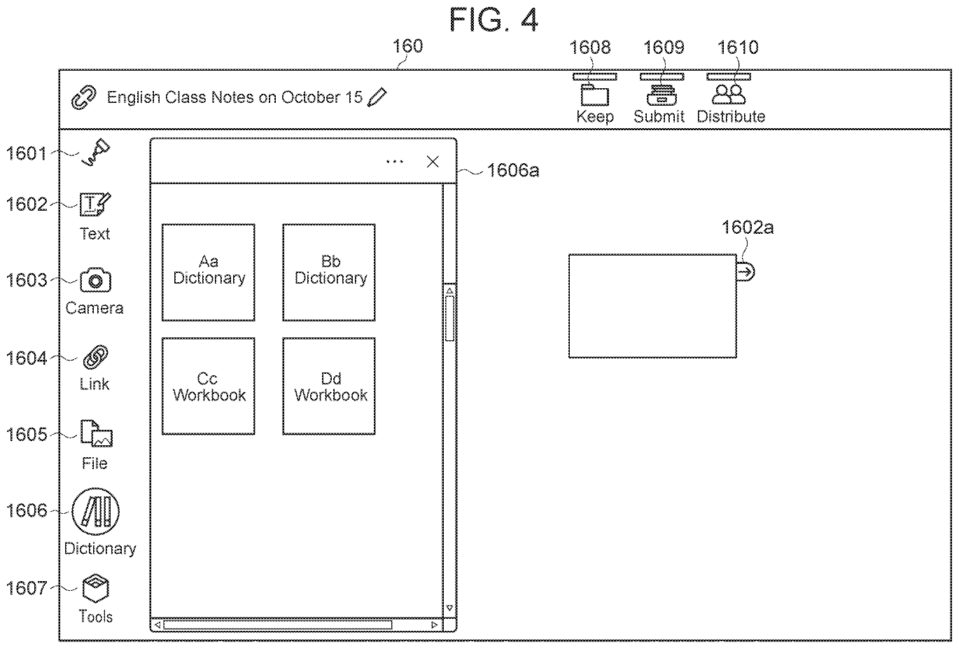

FIG. 4 is a diagram illustrating an example of a screen display by an application running on the web browser of the terminal 10. A screen 160 displayed on the display device 16 of the terminal 10 includes a work area (display area) called “notebook.” In the notebook, a plurality of icons (hereinafter, referred to as “sticky note icons”) are displayed to select the type of electronic sticky note to be created. The plurality of sticky note icons includes sticky note icons 1601, 1602, 1603, 1604, 1605, 1606, and 1607. By selecting these sticky note icons, various electronic sticky notes are able to be displayed in the notebook. An electronic sticky note is an object (a display body) with a small display area for displaying various information related to a web application. The electronic sticky note may be a floating object that is able to be placed at an arbitrary position in the display area (the work area of the notebook) and whose at least display position is able to be changed according to a user operation.

The sticky note icon 1601 is a hand-drawn sticky note icon for displaying an electronic sticky note for a user's hand-drawn input. When the sticky note icon 1601 is selected, a hand-drawn sticky note capable of accepting a user's hand-drawn input is displayed in the notebook.

The sticky note icon 1602 is a text sticky note icon for displaying an electronic sticky note for user's text input. When the sticky note icon 1602 is selected, a text sticky note capable of accepting a user's text input is displayed in the notebook. The electronic sticky note 1602a in FIG. 4 is a text sticky note.

The sticky note icon 1603 is a camera sticky note icon for displaying an electronic sticky note for accepting user's image input. When the sticky note icon 1603 is selected, a camera sticky note capable of accepting an image input is displayed in the notebook and a camera of the terminal 10, which is not illustrated, is activated, and an image obtained by the camera is pasted on this camera sticky note.

The sticky note icon 1604 is a link sticky note icon for displaying an electronic sticky note for web page operation. When the sticky icon 1604 is selected, an input of a universal resource locator (URL) is accepted. By entering the URL, the link sticky note with the corresponding web page being displayed is displayed in the notebook. The user is able to perform operations on the Web page in the link sticky note.

The sticky note icon 1605 is a file sticky note icon for displaying an electronic sticky note for file operations. When the sticky icon 1605 is selected, file selection is accepted. By the file selection, a file sticky note with the content of the file being displayed is displayed in the notebook. The user is able to perform operations on the corresponding file in the file sticky note.

The sticky note icon 1606 is a sticky note icon for displaying an electronic sticky note for operations of a dictionary content and a workbook content. When the sticky note icon 1606 is selected, a dictionary sticky note 1606a for accepting the user's selection of a dictionary content and a workbook content is displayed in the notebook. By selecting a desired dictionary content or workbook content, the user is able to perform operations on the corresponding dictionary or workbook content inside or outside the dictionary sticky note.

The sticky note icon 1607 is a sticky note icon for displaying various tool sticky notes for accepting inputs other than text, such as formulas, graphs, and spreadsheets. When the sticky note icon 1607 is selected, a tool selection is further accepted. By selecting a tool, a tool sticky note for creating a formula or the like is displayed in the notebook. The user is able to create a formula or the like in the tool sticky note.

The notebook also displays a keeping icon 1608, a submission icon 1609, and a distribution icon 1610. The keeping icon 1608 is an icon selected by a user to keep the electronic sticky note created in the current notebook. When the keeping icon 1608 is selected, the data of the electronic sticky note created by the user is kept in the storage 24 of the server 20. The submission icon 1609 is an icon selected by the user when he/she submits the electronic sticky note created in the current notebook to a predetermined submission destination. For example, in the case where the user is a student, the predetermined submission destination is a teacher. When the user selects the submission icon 1609, the teacher is notified that the user has submitted an electronic sticky note. The teacher is able to view the electronic sticky note submitted by the user by selecting a link set according to this notification. The distribution icon 1610 is an icon selected by the user when sending the electronic sticky note created in the current notebook to an arbitrary distribution destination. When the user selects the distribution icon 1610 and sets the transmission destination, the transmission destination is notified of the distribution of the electronic sticky note from the user. The user at the transmission destination is able to view the distributed electronic sticky note by selecting the link set according to the notification.

In this specification, the screen in FIG. 4 is merely an example. Not all icons illustrated in FIG. 4 need to be necessarily displayed. It is also possible to display more icons not illustrated in FIG. 4. In addition, a plurality of related electronic sticky notes may be tied together by a string, for example, to illustrate their relationship.

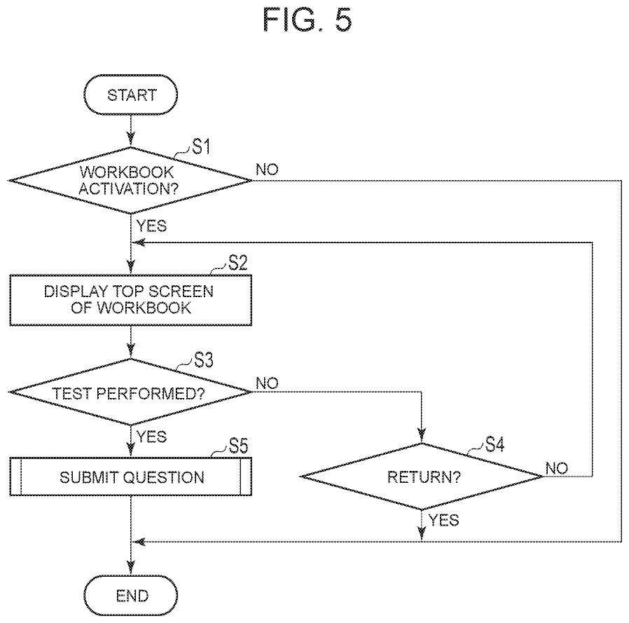

The operation of the system 1 is described below. FIG. 5 is a flowchart illustrating the workbook content execution process on the terminal 10. The following description assumes a situation in which a user executes an English workbook content to perform self-study of English. In the following description, it is also assumed that the communication connection between the terminal 10 and the server 20 is established, and the web application downloaded from the server 20 is running on the web browser of the terminal 10.

In step S1, the processor 11 of the terminal 10 determines whether to activate the workbook content. For example, when the user selects the shortcut icon of the workbook content in the dictionary sticky note displayed in the notebook, it is determined that the workbook content is to be activated. This is not the only way to activate the workbook content. For example, the workbook content may be determined to be activated when the shortcut icon of the workbook content, which is provided separately from the dictionary sticky note, is selected. In the case where the workbook content is determined to be activated in step S1, the process proceeds to step S2. In the case where it is not determined to activate the workbook content in step S1, the process in FIG. 5 is terminated. In this case, various processes other than the workbook content may be performed on the web application. The description of the various processes other than workbook content is omitted.

In step S2, the processor 11 displays the top screen of the workbook content. For this purpose, the processor 11 requests the data of the workbook content selected by the user from the server 20. Upon receiving the workbook content data from the server 20, the processor 11 displays the top screen of the workbook content on the web browser. The top screen of the workbook content may be displayed in the dictionary sticky note or outside the dictionary sticky note.

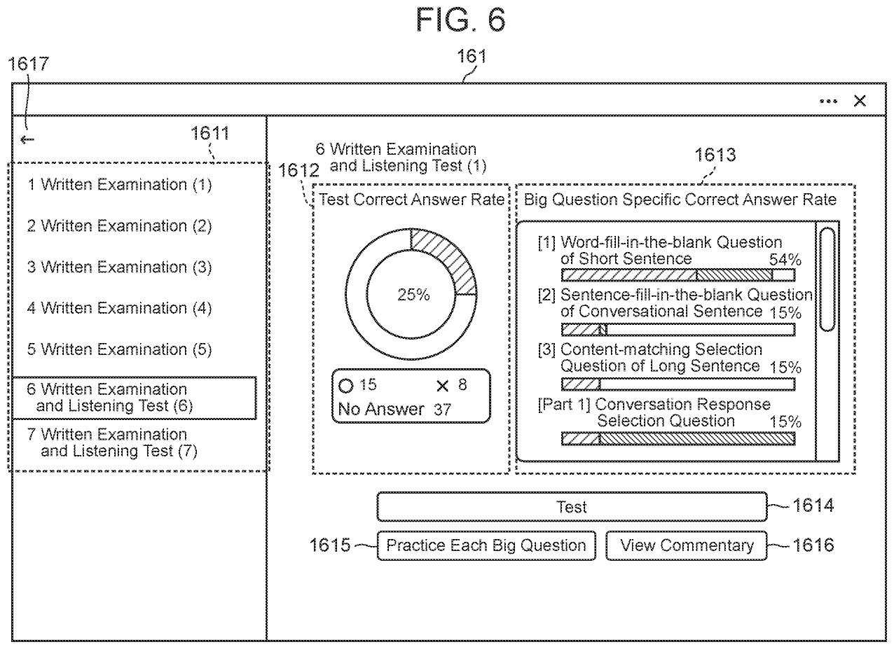

FIG. 6 illustrates an example of the top screen of the workbook content. The top screen 161 has a test selection area 1611, a test correct answer rate display area 1612, and a big question specific correct answer rate display area 1613.

In the test selection area 1611, respective test names that constitute the workbook content are listed. A test name selected by the user is displayed in a box, for example. In the test correct answer rate display area 1612 and the big question specific correct answer rate display area 1613, information about the test selected in the test selection area 1611 is displayed. In this respect, test names not able to be displayed in the test selection area 1611 may be displayed by scrolling.

The test correct answer rate display area 1612 is a display area for displaying the correct answer rate based on the most recent scoring results of the currently selected test. In the test correct answer rate display area 1612, for example, a pie chart illustrating the proportion of correct answers, incorrect answers, and no answers for the currently selected test may be displayed. Near the pie chart, the percentage of the correct answers, which is the ratio of the number of correct answers to the total number of questions in the currently selected test, may be displayed. In addition, the actual number of correct answers, that of incorrect answers, and that of no answers in the currently selected test may be displayed in the test correct answer rate display area 1612. By viewing the display in the test correct answer rate display area 1612, the user is able to roughly grasp the result of the most recent test performed by the user.

The big question specific correct answer rate display area 1613 is a display area for displaying the correct answer rate for each big question based on the most recent scoring results for the currently selected test. For example, a stacked horizontal bar chart illustrating the proportion of correct answers, incorrect answers, and no answers for each big question contained in the currently selected test may be displayed in the big question specific correct answer rate display area 1613. Near the stacked horizontal bar chart, the percentages of correct answers, each of which is the ratio of the number of correct answers to the total number of questions in the corresponding big question, may be displayed. By viewing the display of the big question specific correct answer rate display area 1613, the user is able to grasp which questions he/she is good at and which questions he/she is not so good at. Note that the correct answer rates of big questions not able to be fully displayed in the big question specific correct answer rate display area 1613 may be displayed by scrolling.

As will be described later, the questions used in calculating the correct answer rates in the test correct answer rate display area 1612 and the big question specific correct answer rate display area 1613 are desirably only questions that have unique correct answers such as selection questions or the like and do not require self-determination by the user. This is because it is difficult to correctly evaluate the scoring results when scoring results are used for the calculation of the correct answer rates by treating the scoring results for questions for which answers are not able to be easily separated into correct and incorrect answers in the same manner as the scoring results for questions for which answers are able to be easily separated into correct and incorrect answers.

In addition, a test button 1614 and a practice button 1615 are displayed on the top screen 161. The test button 1614 is a button selected by the user to start the currently selected test. The practice button 1615 is a button selected by the user to practice the currently selected test for each big question. When the practice button 1615 is selected, a menu for selecting a big question is also displayed. When a big question is selected by the user, a test only for the corresponding big question is started.

In addition, a commentary button 1616 may be displayed on the top screen 161. The commentary button 1616 is a button selected by the user to display a commentary such as points of the currently selected test. In addition, a back button 1617 may be displayed on the top screen 161. The back button 1617 is a button selected by the user to exit the workbook content.

Returning to the description of FIG. 5, in step S3 after displaying the top screen 161, the processor 11 determines whether to perform the test. In the case where the test button 1614 or the practice button 1615 is selected on the top screen 161, it is determined that the test is to be performed. In the case where the test is not determined to be performed in step S3, the process proceeds to step S4. In the case where the test is determined to be performed in step S3, the process proceeds to step S5.

In step S4, the processor 11 determines whether to return from the top screen 161. In the case where the back button 1617 is selected on the top screen 161, returning from the top screen 161 is determined to be performed. In the case where returning from the top screen 161 is not determined to be performed in step S4, the process returns to step S2. In the case where returning from the top screen 161 is determined to be performed in step S4, the process of FIG. 5 is terminated. When the process of FIG. 5 is terminated, in the case where the workbook content is activated separately from the dictionary sticky note, the process of FIG. 5 is terminated by closing the window of the top screen. On the other hand, when the process of FIG. 5 is terminated, in the case where the workbook content is activated in the dictionary sticky note, the process of FIG. 5 is terminated when the display of the top screen in the dictionary sticky note disappears.

In step S5, the processor 11 performs the process of submitting questions. After the process of submitting questions, the process of FIG. 5 ends. The process of submitting questions is a series of processes for submitting test questions to the user. The process of submitting questions is described in detail later.

Although the description is omitted in FIG. 5, a process of updating the displays of the test correct answer rate display area 1612 and the big question specific correct answer rate display area 1613 may be performed when a big question name is selected in the test selection area 1611, and a process of displaying a commentary may be performed when the commentary button 1616 is selected.

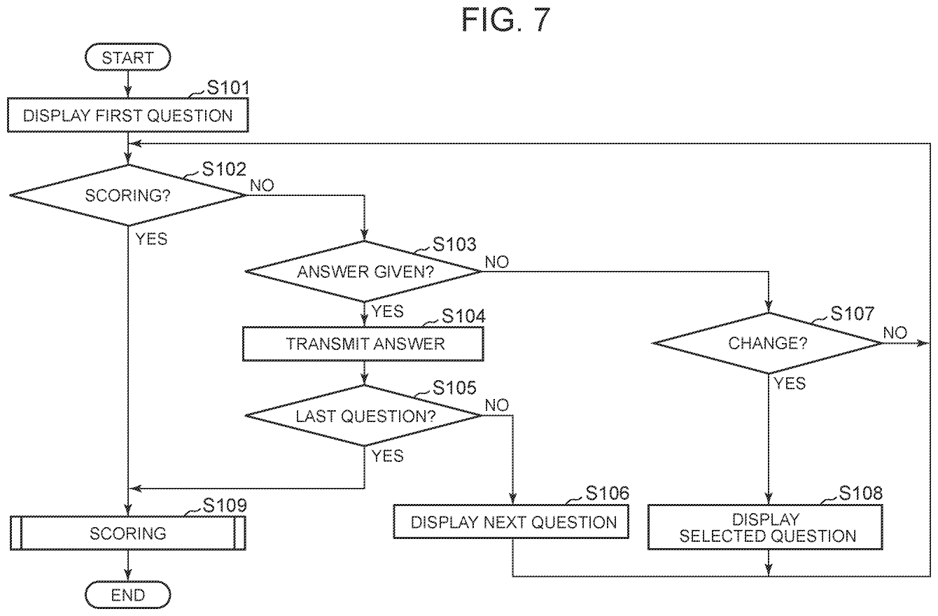

FIG. 7 is a flowchart illustrating the process of submitting questions. In step S101, the processor 11 displays a first question of the selected test or big question.

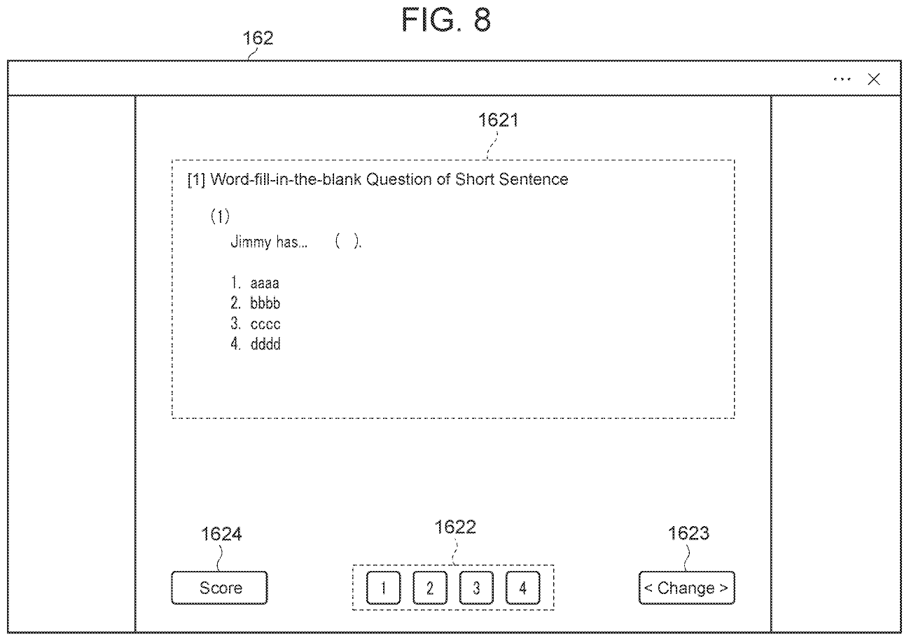

FIG. 8 is a diagram illustrating a first example of a display screen for a question. The first example illustrates a display screen in the case of a word-fill-in-the-blank question. The word-fill-in-the-blank question is a question in which the examinee is supposed to answer the word that fits the vacancy in a short sentence from among a plurality of choices. In other words, the word-fill-in-the-blank question is an example of a question for which the correct answer is uniquely determined and the answer result is able to be easily determined to be a correct or incorrect answer.

A question display screen 162 for the word-fill-in-the-blank question has a question display area 1621 and a choice display area 1622.

The question display area 1621 is a display area for displaying a short sentence containing a blank used for a question and an answer candidate choice. In this respect, questions not able to be fully displayed in the question display area 1621 may be displayed by scrolling.

The choice display area 1622 is a display area for displaying buttons corresponding to answer choices.

In addition, a change button 1623 and a scoring execution button 1624 are displayed in the question display area 1621 for a word-fill-in-the-blank question. The change button 1623 is a button selected by the user to change the question. When the change button 1623 is selected, the control waits for the user to select whether to return to the previous question or to proceed to the next question. According to this selection, the respective displays of the question display area 1621 and the choice display area 1622 are updated. The scoring execution button 1624 is a button selected by the user to terminate the test. When the scoring execution button 1624 is selected, the scoring process described later is started.

In FIG. 8, an example of a word-fill-in-the-blank question is illustrated. Other than the word-fill-in the-blank question, questions with choices for answers may also be displayed on the screen containing the choice buttons illustrated in FIG. 8. In addition to the above, as questions in which correct answers are uniquely determined, there may be English translations of words, Japanese translations, and so on. In this case, an input field for entering the meaning of a word or the like is displayed for text input, instead of a choice.

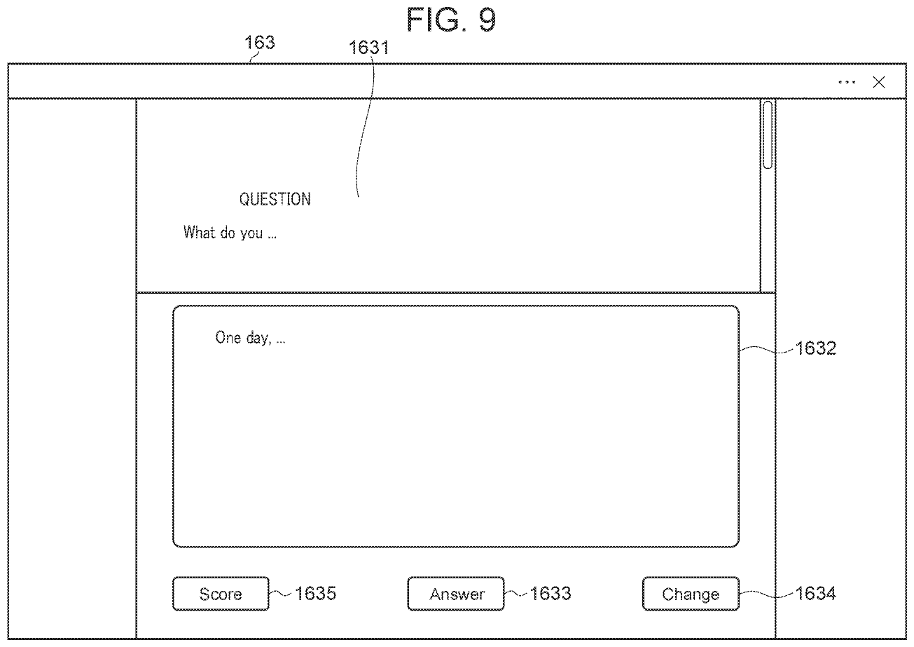

FIG. 9 is a diagram illustrating a second example of a display screen for a question. The second example illustrates a display screen for an English composition question. The English composition question is, for example, an essay-type question in which the examinee writes an answer in English to a question given in a text or the like. In other words, an English composition question is an example of a question for which the correct answer is not uniquely determined, and the answer result is not able to be easily determined to be a correct or incorrect answer.

The question display screen 163 for an English composition question has a question display area 1631 and an answer input field display area 1632.

The question display area 1631 is a display area for displaying an English text as a question to the user. Note that questions not able to be displayed in the question display area 1631 may be displayed by scrolling. In addition to the English text as the question, a Japanese text may be displayed to describe the question depending on the question. Such a Japanese text for describing the question may be displayed separately from the display screen of the question, or may be switched from the question display area 1631 by a button operation or the like.

The answer input field display area 1632 is a display area for the user to input his/her answer. In the answer input field display area 1632, a text input is able to be accepted. The user is able to freely input text in the answer input field display area 1632.

In the question display area 1631 for an English composition question, there are displayed an answer complete button 1633, a change button 1634, and a scoring execution button 1635. The answer complete button 1633 is a button selected by the user when the user terminates the input of an answer into the answer input field display area 1632. The change button 1634 is a button selected by the user to changes the question. When the change button 1634 is selected, the control waits for the user to select whether to return to the previous question or to proceed to the next question. According to the selection, the displays of the question display area 1631 and the answer input field display area 1632 are updated. The scoring execution button 1635 is a button that is selected by the user to terminate the test. When the scoring execution button 1635 is selected, the scoring process described later is started.

FIG. 9 illustrates an example of an English composition question. Other than the English composition question, questions for which the correct answer is not uniquely determined are also displayed on a screen that does not contain choice buttons, in the same way as the English composition question. For example, in the case of a speaking question, a button that accepts the user's voice recording may be displayed instead of the answer input field display area 1632.

Now back to the description of FIG. 7. In step S102 after displaying the question, the processor 11 determines whether to perform scoring. In the case where the user selects the scoring execution button 1624 or 1635, scoring is determined to be executed. In the case where scoring is not determined to be executed in step S102, the process proceeds to step S103. In the case where scoring is determined to be executed in step S102, the process proceeds to step S109.

In step S103, the processor 11 determines whether the user gave an answer. In the case of a word-fill-in-the-blank question or the like, it is determined that the user gave an answer when any of the choice buttons is selected, and in the case of an English composition question or the like, it is determined the same way when the answer completion button is selected. In step S103, in the case where it is determined that the user gave an answer, the process proceeds to step S104. In the case where it is not determined that the user gave an answer in step S103, the process proceeds to step S107.

In step S104, the processor 11 transmits the data of the answer entered by the user to the server 20, associating the data with the test ID and the question ID. As described later, when receiving the answer data from the terminal 10, the processor 21 of the server 20 stores the received answer data as user answer data in the test result data 243.

In step S105, the processor 11 determines whether the question answered by the user is the last question. In the case where a test is being conducted from the test button 1614, and when the question answered by the user is the last question of the corresponding test, it is determined that the question answered by the user is the last question. In the case where a test is being conducted from the practice button 1615, and when the question answered by the user is the last question of the corresponding big question, it is determined that the question answered by the user is the last question. In the case where, in step S105, the question answered by the user is not determined to be the last question, the process proceeds to step S106. In the case where, in step S105, the question answered by the user is determined to be the last question, the process proceeds to step S109.

In step S106, the processor 11 displays the next question of the selected test or of big question. Thereafter, the process returns to step S102.

In step S107, the processor 11 determines whether to change the question. In the case where the change button is selected by the user, it is determined that the question is to be changed. In the case where it is determined that the question is to be changed, the process proceeds to step S108. In the case where it is not determined that the question is to be changed in step S107, the process returns to step S102.

In step S108, the processor 11 displays the question specified by the user among the selected tests or big questions. Thereafter, the process returns to step S102.

In step S109, the processor 11 performs the scoring process. After the scoring process, the process in FIG. 7 is terminated. The scoring process is performed to score the user's answers.

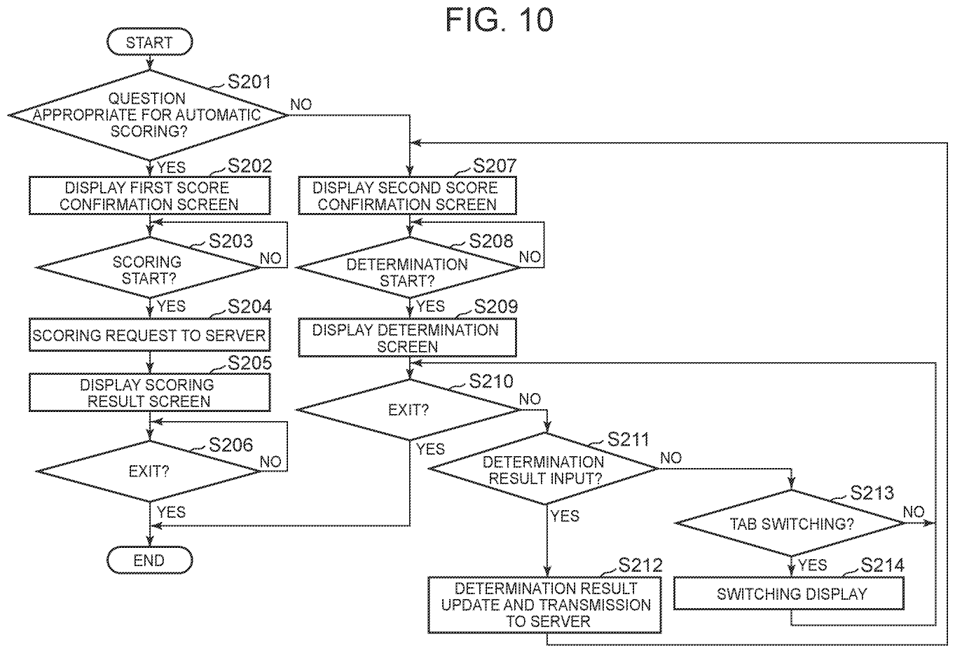

FIG. 10 is a flowchart illustrating a scoring process. In step S201, the processor 11 determines whether the question to be scored is an appropriate question for automatic scoring. In the embodiment, an appropriate question for automatic scoring is a question for which the correct answer is uniquely determined and the answer result is able to be easily determined to be a correct answer or an incorrect answer. On the other hand, a question for which the automatic scoring is not appropriate is a question for which the correct answer is not uniquely determined and the answer result is not be able to be easily determined to be correct or incorrect. Such questions for which automatic scoring is not appropriate are those for which human determination of the correctness of the answers is appropriate. In the embodiment, each question is assigned with information that indicates whether the question belongs to a question for which automatic scoring is appropriate or not, as one piece of attribute information of the question. The processor 11 determines whether the question to be scored is appropriate for automatic scoring by referring to this attribute information. In the case where it is determined in step S201 that the question to be scored is appropriate for automatic scoring, the process proceeds to step S202. In the case where it is determined in step S201 that the question to be scored is not appropriate for automatic scoring, the process proceeds to step S207.

In step S202, the processor 11 displays a first score confirmation screen. The first score confirmation screen is a screen for the user to confirm whether to perform scoring of the question appropriate for automatic scoring.

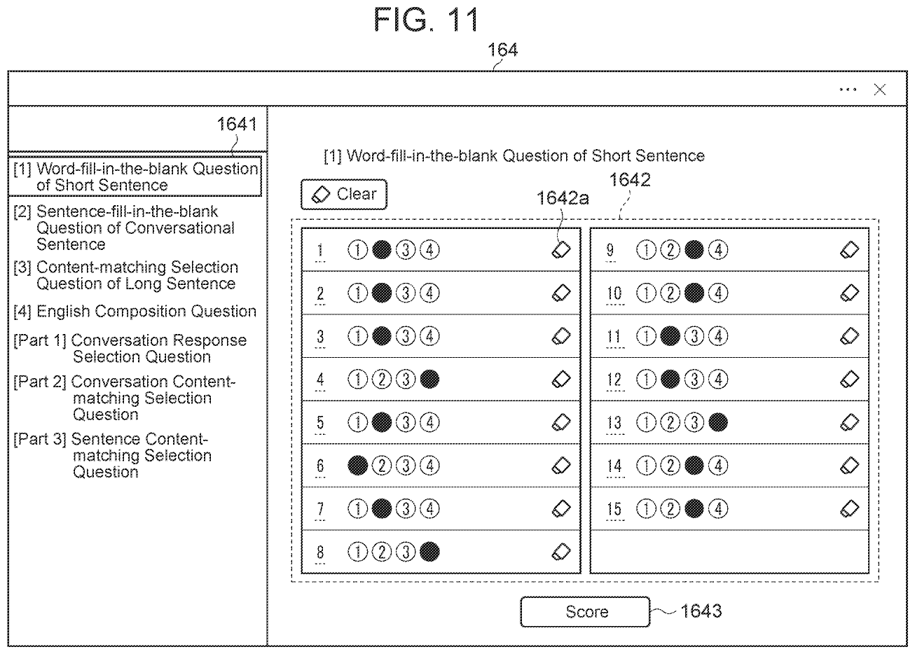

FIG. 11 is a diagram illustrating an example of a first score confirmation screen. Note that the first score confirmation screen in FIG. 11 illustrates an example of the first score confirmation screen for a word-fill-in-the-blank question.

As illustrated in FIG. 11, the first score confirmation screen 164 has a question selection area 1641 and a user answer display area 1642.

In the question selection area 1641, the names of questions that constitute respective big questions are listed. The question name selected by the user is displayed in a box, for example. In the user answer display area 1642, information about the question selected in the question selection area 1641 is displayed. In this respect, the names of questions not able to be displayed in the question selection area 1641 may be displayed by scrolling.

In the user answer display area 1642, the user's answers to the corresponding questions are listed. In the user answer display area 1642 for a test with choices for answers of word-fill-in-the-blank questions or the like, the user's answers may be displayed in a mark-sheet format, for example. Specifically, among the answer candidate choices, the choice to which the user gave an answer is filled in. A clear button 1642a may be displayed near each user's answer in the user answer display area 1642. The clear button 1642a is a button selected by the user to clear the corresponding user's answer. The cleared answers are treated as unanswered.

In addition, the first score confirmation screen 164 displays a scoring execution button 1643. The scoring execution button 1643 is a button selected by the user to start scoring.

Now back to the description of FIG. 10. In step S203, the processor 11 determines whether to start scoring. In the case where the scoring execution button 1643 is selected, scoring is determined to be started. In the case where scoring is determined to be started in step S203, the process proceeds to step S204. In the case where scoring is not determined to be started in step S203, the process is put on standby. Note that, although the description is omitted in FIG. 10, the display in the user answer display area 1642 may be updated when a question name is selected in the question selection area 1641, in the case where scoring is not determined to be started. The display of the first score confirmation screen 164 may be terminated when a predetermined termination condition is satisfied, such as when there is no operation on the first score confirmation screen 164 for a certain period of time. When the display of the first score confirmation screen 164 is terminated, the process in FIG. 10 ends.

In step S204, the processor 11 requests the server 20 to automatically score the corresponding test. After receiving the automatic scoring result from the server 20, the process proceeds to step S205.

In step S205, the processor 11 displays a scoring result screen on the basis of the automatic scoring result. The scoring result screen is a screen for the user to confirm the result of the automatic scoring.

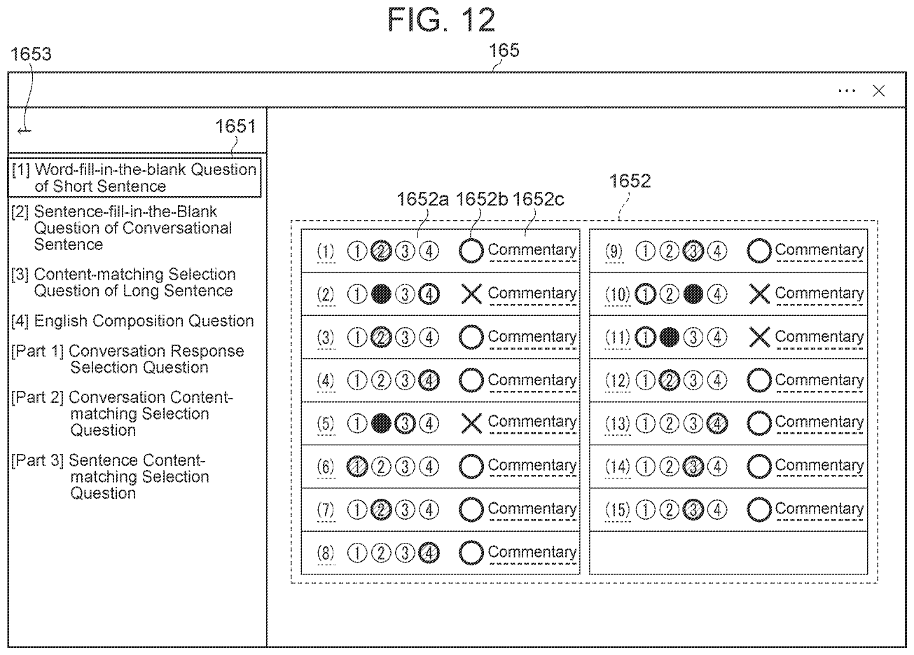

FIG. 12 is a diagram illustrating an example of the scoring result screen. Note that the scoring result screen in FIG. 12 illustrates an example of a scoring result screen for a word-fill-in-the-blank question, as in FIG. 11.

The scoring result screen 165 has a question selection area 1651 and a scoring result display area 1652.

In the question selection area 1651, the names of questions that constitute respective big questions are listed. The question name selected by the user is displayed in a box, for example. In the scoring result display area 1652, the scoring results for the questions selected in the question selection area 1651 are displayed. Note that the names of questions not able to be displayed in the question selection area 1651 may be displayed by scrolling.

In the scoring result display area 1652, the scoring results for the corresponding questions are listed. The scoring result display area 1652 has a comparison display 1652a, a scoring result 1652b, and a commentary link 1652c. In the comparison display 1652a, a user's answer and an actual answer are displayed together. In the comparison display 1652a for a test with choices for an answer, the user's answer and the actual answer may be displayed in a mark-sheet format, for example. Specifically, among the answer candidate choices, the user's answer choice that does not correspond to the actual answer is displayed as a fill. In this case, the actual answer choice is displayed with a bold frame. In addition, the choice where the user's answer matches the actual answer is displayed with a bold frame and colored. By these displays, the user is able to easily understand whether his/her answer matches the correct answer. A scoring result is displayed in the scoring result 1652b. For example, a correct answer is marked with a circle, and an incorrect answer is marked with a cross. In the case of no answer, the scoring result 1652b may be empty, or a character string such as “Unanswered” may be displayed. The commentary link 1652c is a link selected by the user to display a commentary about a corresponding question. When the commentary link 1652c is selected, the commentary of the predefined link destination is displayed in a dialog, for example.

Moreover, the scoring result screen 165 may also display a back button 1653. The back button 1653 is a button selected by the user to exit the display of the scoring result screen 165.

Now back to the description of FIG. 10. In step S206, the processor 11 determines whether to exit the display of the scoring result screen. When the back button 1653 is selected, the display of the scoring result screen is determined to be exited. In the case where the display of the scoring result screen is not determined to be exited in step S206, the process is put on standby. Although the description is omitted in FIG. 10, a process of updating the display of the scoring result display area 1652 may be performed when a problem name is selected in the problem selection area 1651, and a process of displaying the corresponding question commentary may be performed when the commentary link 1652c is selected. In the case where it is determined in step S206 that the display of the scoring result screen is exited, the process in FIG. 10 ends.

In step S207, the processor 11 makes a self-determination request for self-determination. After receiving information needed for self-determination from the server 20, the processor 11 displays a second score confirmation screen. The second score confirmation screen is used for the user to confirm whether to perform self-determination for a question for which automatic scoring is not appropriate.

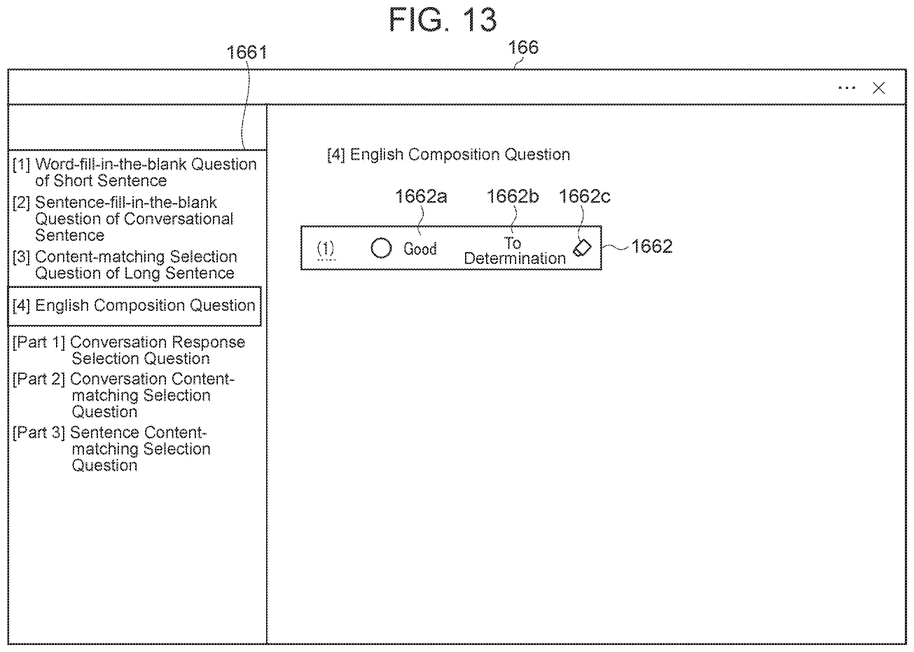

FIG. 13 is a diagram illustrating an example of a second score confirmation screen. Note that the second score confirmation screen in FIG. 13 illustrates an example of the second score confirmation screen for an English composition question.

As illustrated in FIG. 13, the second score confirmation screen 166 has a question selection area 1661, a question selection area 1661, and a determination result display area 1662.

In the question selection area 1661, the names of questions that constitute respective big questions are listed. The question name selected by the user is displayed in a box, for example. In the determination result display area 1662, information about the question selected in the question selection area 1661 is displayed. Note that the names of questions not able to be displayed in the question selection area 1661 may be displayed by scrolling.

In the determination result display area 1662, the user's self-determination result for the corresponding question is displayed. Although the self-determination result for one question is displayed in FIG. 13, a plurality of determination result display areas 1662 may be displayed in the case where the corresponding big question contains a plurality of questions. In the determination result display area 1662, a determination result 1662a, a determination execution button 1662b, and a clear button 1662c may be displayed. In the determination result 1662a, the user's self-determination result is displayed. As described later, the self-determination result may be displayed in three levels as “Good,” “Average,” and “Poor.” In other words, the self-determination result may include other choices than “correct answer” and “incorrect answer.” In the case where the corresponding question is unanswered, the determination result 1662a may be empty or may display a character string such as “Unanswered.” The determination execution button 1662b is a button selected by the user to perform self-determination. When the user performs self-determination, the display of the determination result 1662a is updated. The clear button 1662c is a button selected by the user to clear the corresponding determination result. When cleared, the determination result is treated as unanswered.

Now back to the description of FIG. 10. In step S208, the processor 11 determines whether to start self-determination. In the case where the determination execution button 1662b is selected, self-determination is determined to be started. In the case where the self-determination is determined to be started in step S208, the process proceeds to step S209. In the case where the self-determination is not determined to be started in step S208, the process is put on standby. Note that, although the description is omitted in FIG. 10, a process of updating the display of the determination result display area 1662 may be performed in the case where the question name is selected in the question selection area 1661 when the scoring is not determined to be started. Moreover, a process of exiting the display of the second score confirmation screen 166 may be performed when a predetermined termination condition is satisfied, such as when there is no operation on the second score confirmation screen 166 for a certain period of time. When the display of the second score confirmation screen 166 is exited, the process in FIG. 10 ends.

In step S209, the processor 11 displays a determination screen. The determination screen is a screen for the user to perform self-determination.

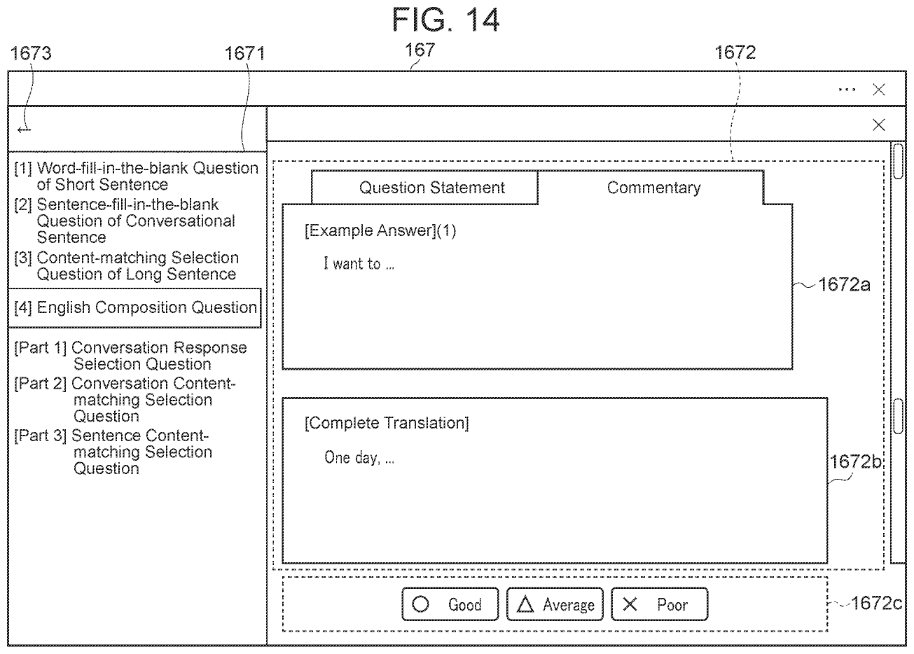

FIG. 14 is a diagram illustrating an example of a determination screen. Note that the determination screen in FIG. 14 illustrates an example of a determination screen for an English composition question similarly to FIG. 13.

The determination screen 167 has a question selection area 1671 and a determination result input area 1672.

In the question selection area 1671, the names of questions that constitute respective big questions are listed. The question name selected by the user is displayed in a box, for example. In the determination result input area 1672, information about the question selected in the question selection area 1671 is displayed. Note that the names of questions not able to be displayed in the question selection area 1671 may be displayed by scrolling.

The determination result input area 1672 is an area where the user is able to input a self-determination result while comparing a question, his/her own answer, and an example answer. The determination result input area 1672 has a question/commentary display area 1672a, a user answer display area 1672b, and a determination button display area 1672c.

The question/commentary display area 1672a is a display area for displaying either a question statement or a commentary. The question/commentary display area 1672a is, for example, in the form of tabs. By switching the tab, either a question statement or a commentary is displayed in the question/commentary display area 1672a. FIG. 14 illustrates an example in which the commentary is displayed. The question statement is a sentence of a question given to the user for an English composition. On the other hand, the commentary is an example answer for the corresponding question. As mentioned above, the example answer may also contain a commentary. Note that the question statements or commentaries not able to be displayed in the question/commentary display area 1672a may be displayed by scrolling. In addition, as mentioned above, an example answer in the case of a speaking question may include audio. In this case, a play button for playing the audio of the example answer may be displayed in the question/commentary display area 1672a.

The user answer display area 1672b is a display area for English sentences of an answer made by the user. Note that answers not able to be displayed in the user answer display area 1672b may be displayed by scrolling. The English text displayed in the user answer display area 1672b may be used with being copied to various electronic sticky notes such as text sticky notes. Furthermore, as mentioned above, the user's answer in the case of a speaking question may include audio. In this case, a play button for playing the voice of the user's answer may be displayed.

The determination button display area 1672c is a display area for displaying a determination button corresponding to the determination result. In FIG. 14, the determination button includes three buttons: “Good,” “Average,” and “Poor.” Note that the determination result does not necessarily need to be divided into three levels. The determination result may be divided into two levels or four levels. The number of the determination buttons displayed in the determination button display area 1672c changes according to the number of determination result levels.

In addition, a back button 1673 may be displayed on the determination screen 167. The back button 1673 is a button selected by the user to exit the display of the determination screen 167.

Now back to the description of FIG. 10. In step S210, the processor 11 determines whether to terminate the self-determination. In the case where the back button 1673 is selected, the self-determination is determined to be terminated. In the case where the self-determination is determined to be terminated in step S210, the process of FIG. 10 is terminated. In the case where the self-determination is not determined to be terminated in step S210, the process proceeds to step S211. In the example of FIG. 10, it is assumed that the process of FIG. 10 ends when the back button 1673 is selected. When the back button 1673 is selected, however, the control may return to the process of displaying the second score confirmation screen 166 of step S207.

In step S211, the processor 11 determines whether the self-determination result is entered. In the case where any of the determination buttons in the determination button display area 1672c is selected, the self-determination result is determined to be entered. In the case where the self-determination result is determined to be entered in step S211, the process proceeds to step S212. In the case where the self-determination result is not determined to be entered in step S211, the process proceeds to step S213.

In step S212, the processor 11 updates the determination result on the basis of a result entered by the user. The processor 11 also transmits the updated determination result to the server 20, associating the updated determination result with the test ID and the question ID. With the determination result being updated, the display of the determination result display area 1662 on the next second score confirmation screen 166 is also updated.

In step S213, the processor 11 determines whether to switch tabs. In the case where any of the tabs in the question/commentary display area 1672a is selected, it is determined to switch the tab. In the case where it is determined to switch the tab in step S213, the process proceeds to step S214. In the case where it is not determined to switch the tab in step S213, the process returns to step S210.

In step S214, the processor 11 switches the display of the question/commentary display area 1672a according to the selected tab. Thereafter, the process returns to step S210.

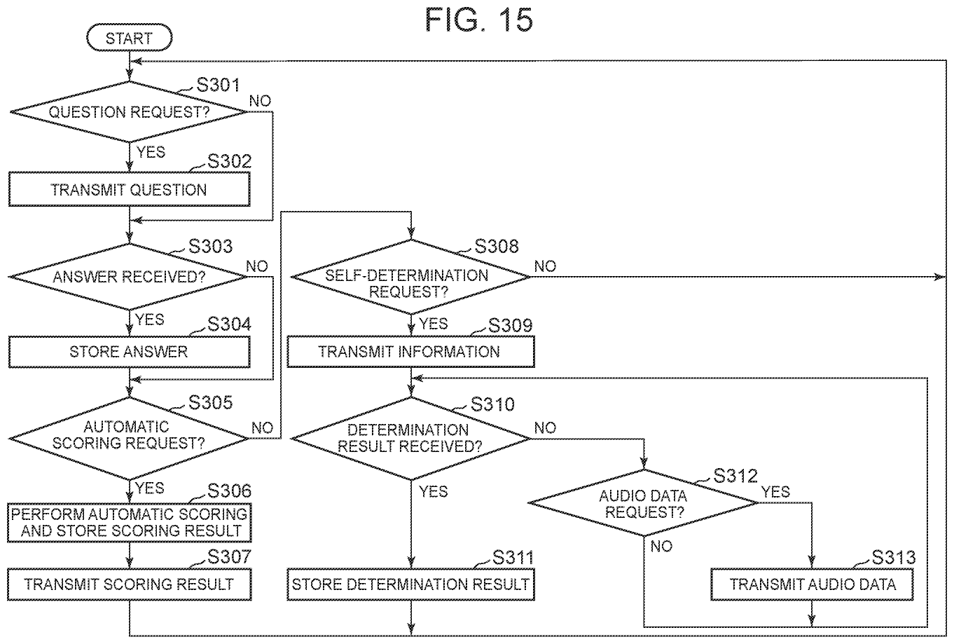

FIG. 15 is a diagram illustrating an operation of the server 20 after the terminal 10 is instructed to start the workbook content. In step S301, the processor 21 of the server 20 determines whether the transmission of the workbook content is requested by the terminal 10. In the case where it is determined that the transmission of the workbook content is requested by the terminal 10 in step S301, the process proceeds to step S302. In the case where it is not determined that the transmission of the workbook content is requested by the terminal 10 in step S301, the process proceeds to step S303.

In step S302, the processor 21 transmits the workbook content requested by the terminal 10. Thereby, the top screen of the workbook content is displayed on the web browser of the terminal 10.

In step S303, the processor 21 determines whether answer data is received from the terminal 10. In the case where it is determined that the answer data is received from the terminal 10 in step S303, the process proceeds to step S304. In the case where it is not determined that the answer data is received from the terminal 10 in step S303, the process proceeds to step S305.

In step S304, the processor 21 stores the received answer data into the storage 24, as user answer data in the test result data 243, by referring to the test ID and the question ID associated with the received answer data.

In step S305, the processor 21 determines whether an automatic scoring request is received from the terminal 10. In the case where it is determined in step S305 that an automatic scoring request is received from the terminal 10, the process proceeds to step S306. In the case where it is not determined in step S305 that an automatic scoring request is received from the terminal 10, the process proceeds to step S309.

In step S306, the processor 21 performs automatic scoring for the requested question. Specifically, the processor 21 determines a correct or incorrect answer to the question by comparing the stored user answer data with the answer data as determination data stored in the storage 24 in advance. After automatic scoring, the processor 21 calculates a correct answer rate. Then, the processor 21 stores the automatic scoring result in the storage 24 as a scoring result of the test result data 243.

In step S307, the processor 21 transmits the automatic scoring result to the terminal 10. Thereafter, the process returns to step S301. The automatic scoring result includes the correct or incorrect answer result and the correct answer rate for each question. Thereby, the scoring result screen 165 may be displayed on the terminal 10.

In step S308, the processor 21 determines whether a self-determination request is received from the terminal 10. In the case where it is determined in step S308 that a self-determination request is received from the terminal 10, the process proceeds to step S309. In the case where it is not determined in step S308 that the self-determination request is received from the terminal 10, the process returns to step S301.

In step S309, the processor 21 transmits the information necessary for self-determination, specifically, the user's answer data and the data of the most recent self-determination result, to the terminal 10. This allows the second score confirmation screen 164 and the scoring result screen 165 to be displayed on the terminal 10.

In step S310, the processor 21 determines whether the self-determination result is received from the terminal 10. In the case where it is determined in step S310 that the self-determination result is received from the terminal 10, the process proceeds to step S311. In the case where it is not determined in step S310 that the self-determination result is received from the terminal 10, the process proceeds to step S312.

In step S311, the processor 21 stores the received self-determination result data as the scoring result data of the test result data 243 into the storage 24, by referring to the test ID and the question ID associated with the received self-determination result data. Thereafter, the process returns to step S301.

In step S312, the processor 21 determines whether a request for audio data of a user's answer or an example answer is received from the terminal 10. In the case where it is determined in step S312 that a request for audio data of a user's answer or example answer is received from the terminal 10, the process proceeds to step S313. In the case where it is not determined in step S312 that a request for audio data of the user's answer or the example answer is received from the terminal 10, the process returns to step S310.

In step S313, the processor 21 transmits the requested audio data to the terminal 10. Thereafter, the process returns to step S310.

As described above, according to the present embodiments, a scoring button for the user to perform scoring by himself/herself is displayed in the case of a question for which automatic scoring is not appropriate, such as, for example, a question for which a correct answer is not uniquely determined and answer results cannot be easily divided into correct and incorrect answers. This allows the user to perform self-determination as necessary. In addition, at the self-determination, the user is able to perform determination while comparing a question, his/her own answer, and an example answer. Thereby, increasing the accuracy of the determination is expected, which also leads to improvement of the usability at the determination.

In the embodiment, the result of self-determination is not included in the calculation of the correct answer rate of the test. In other words, the correct answer rate in the embodiment is the correct answer rate for a question for which answer results are able to be easily divided into correct and incorrect answers, and therefore a user is able to objectively evaluate his/her own learning status from the correct answer rate.

In addition, the server stores the user's answers and scoring results in separate formats between questions for which answer results are able to be easily divided into correct and incorrect answers and questions for which answer results are not able to be easily divided into correct and incorrect answers. Thus, in the embodiment, the scoring results for questions for which answer results are not be able to be easily divided into correct and incorrect answers are able to be properly managed.

### [Variations]

Variations of the embodiments are described below. In the above-mentioned embodiments, the scoring is performed with the user's operation under a test as a trigger. However, the present disclosure is not limited thereto. Since the server stores a question, a user's answer, an answer or example answer, and a scoring result associated with each other, the scoring may be performed at any given time. The person who performs the scoring does not have to be the user himself/herself. For example, the person who performs the scoring may be a person other than the user, such as a teacher or someone else. The server stores a question, a user's answer, and an answer or example answer associated with each other, thereby increasing the usability of determination.

In the above embodiments, a series of processes are performed on a web application in conjunction with the terminal 10 and the server 20. This disclosure, however, is not limited thereto. For example, all the processes may be performed on the terminal 10.

In the embodiments, a word-fill-in-the-blank question is an example of a question for which automatic scoring is appropriate, and an English composition question is an example of a question for which automatic scoring is not appropriate. This disclosure, however, is not limited thereto. A question for which automatic scoring is appropriate may be any question for which a correct answer is uniquely determined. Similarly, a question for which automatic scoring is not appropriate may be any question for which a correct answer is not uniquely determined. For example, a question for which automatic scoring is not appropriate may include a Japanese composition question, a dissertation question, a mathematical proof question, and so on.

The present disclosure is not limited to the above embodiments, but may be modified in various ways in the implementation stage without departing from the gist of the invention. In addition, the embodiments may be appropriately combined as much as possible, in which case the combined effect will be obtained. Furthermore, the above embodiments include inventions in various stages, and various inventions may be extracted by appropriate combinations of a plurality of compositional requirements disclosed in the embodiments.

What is claimed is:

1. An information processing apparatus comprising a control unit that performs the processes of:
displaying a determination screen for having a person who determines make a determination on an answer made by a person who answers on a display device in a case where it is specified that a person determines whether the answer is good or not for a question answered by the person who answers; and
storing a result of the determination by the person who determines entered on the determination screen in association with the question into a memory.

2. The information processing apparatus according to claim 1, wherein the determination screen has a first area for displaying a model answer, a second area for displaying the user's answer, and a third area for entering the determination result.

3. The information processing apparatus according to claim 2, wherein the control unit displays the determination screen in such a way that the person who determines is able to enter the determination result in the third area with the model answer and the answer by the person who answers being simultaneously displayed in the first and second areas in the determination screen, in a comparable state for the person who determines.

4. The information processing apparatus according to claim 1 that performs the processes of:
selecting either of a first process of performing a determination process of determining whether the answer is correct or incorrect for the question answered by the person who answers, using the pre-stored data for determining a correct or incorrect answer and a second process of entering a determination result obtained by the person who determines by determining whether the answer is good or not without performing the determination process using the data for the determination;
storing the determination result, obtained by performing the determination process in association with the question, into the memory in the case where the first process is selected; and
storing the entered determination result in association with the question into the memory in the case where the second process is selected.

5. The information processing apparatus according to claim 4, wherein the control unit performs a process of selecting the first process in the case where the question answered by the person who answers is a choice type question and selecting the second process in the case where the question answered by the person who answers is a question to be answered by writing or by voice.

6. The information processing apparatus according to claim 4, wherein the control unit performs the processes of:
determining whether it is more appropriate that the person who determines makes a determination of whether the answer is good or not than that whether the answer is correct is automatically determined; and
selecting the second process in the case of determining that it is more appropriate that the person who determines makes a determination of whether the answer is good or not.

7. The information processing apparatus according to claim 1, wherein the control unit switches between displaying the model answer and displaying the question in the first area.

8. The information processing apparatus according to claim 1, wherein the determination result contains at least three choices of determination result.

9. The information processing apparatus according to claim 1, wherein the control unit places an electronic sticky note in a predetermined display area of the display device according to the user's operation and displaying the question and/or the determination screen within the electronic sticky note.

10. An information processing method wherein an information processing apparatus performs the processes of:
displaying a determination screen for having a person who determines make a determination on an answer made by a person who answers on a display device in the case where it is specified that a person determines whether the answer is good or not for a question answered by the person who answers; and
storing a result of the determination by the person entered on the determination screen in association with the question into a memory.

11. A non-transitory recording medium storing a program for causing a computer to perform the processes of:
displaying a determination screen for having a person who determines make a determination on an answer made by a person who answers on a display device in the case where it is specified that a person determines whether the answer is good or not for a question answered by the person who answers; and
storing a result of the determination by the person entered on the determination screen in association with the question into a memory.
